(19) United States
(12) Patent Application Publication
(10) Pub. No.: US 2018/0038704 A1
(43) Pub. Date: Feb. 8, 2018

(54) RECOMMENDATION SERVICE SYSTEMS AND METHODS

(71) Applicant: Intertrust Technologies Corporation, Sunnyvale, CA (US)

(72) Inventors: Jarl Nilsson, Mountain View, CA (US); Gadi Ittah, Cupertino, CA (US)

(73) Assignee: Intertrust Technologies Corporation, Sunnyvale, CA (US)

(21) Appl. No.: 15/669,204

(22) Filed: Aug. 4, 2017

Related U.S. Application Data
(60) Provisional application No. 62/371,511, filed on Aug. 5, 2016.

(51) Int. Cl. G01C 21/34; G01C 21/36; G06Q 50/30

(52) U.S. Cl. CPC G01C 21/3438; G06Q 50/30; G01C 21/3661; G01C 21/3476; G06Q 30/0239

(57) ABSTRACT

This disclosure relates to systems and methods for recommending information to passengers. In certain embodiments, based on potential passenger interests, one or more intermediate points of interest may be identified and provided to a mobile device associated with a driver of a transportation service for personal recommendation to a passenger. Potential passenger interests may be identified from direct interaction between a driver and a passenger, based on interferences derived from the nature of an indicated destination, and/or the like. Providing targeted and personalized recommendations to a captive audience such as a passenger of a transportation service may, among other things, allow for more efficient targeting of recommendations that are well matched to a passenger's interests during a trip, and are therefore more likely to be acted on by a passenger.

### RELATED APPLICATIONS

This application claims the benefit of priority under 35 U.S.C. §119(e) to U.S. Provisional Patent Application No. 62/371,511, filed Aug. 5, 2016, and entitled “RECOMMENDATION SERVICE SYSTEMS AND METHODS,” the content of which is herein incorporated by reference in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### SUMMARY

The present disclosure relates generally to recommendation services. More specifically, but not exclusively, the present disclosure relates to point of interest and other recommendation services offered in connection with a transportation service.

Transportation services including, for example, taxi companies, bus companies, and/or other transportation network companies provide a convenient method for passengers to travel between a variety of destinations. Many transportation services utilize mobile devices and/or associated applications to coordinate services, connect available drivers with interested passengers, and/or provide route directions to indicated destinations. While in transit, passengers of transportation services may be relatively captive audiences. Moreover, transportation services may be well-positioned to identify potential passenger interests, for example, though direct interaction between a driver and a passenger, interferences derived from the nature of an indicated destination, and/or the like.

Systems and methods disclosed herein relate to recommendation and/or information targeting services that may be used in connection with a transportation service. In certain embodiments, based on potential passenger interests, one or more intermediate points of interest (“POIs”) may be identified and provided to a mobile device associated with a driver of a transportation service for recommendation to a passenger (e.g., a personal recommendation). Potential passenger interests may be identified from direct interaction between a driver and a passenger, based on interferences derived from the nature of an indicated destination, and/or the like. Consistent with embodiments disclosed herein, if the passenger choses to visit and/or otherwise act on a recommended POI (e.g., patronizing the POI, accepting an offer, and/or the like), the driver, the transportation service and/or an associated entity may be compensated for providing the realized recommendation. Providing targeted and personalized POI recommendations to a captive audience such as a passenger of a transportation service may, among other things, allow for more efficient targeting of recommended POIs and/or associated information that is well matched to a passenger's interests during a trip, and is therefore more likely to be acted on by a passenger.

### BRIEF DESCRIPTION OF THE DRAWINGS

The inventive body of work will be readily understood by referring to the following detailed description in conjunction with the accompanying drawings, in which:

FIG. 1 illustrates a routing and recommendation service consistent with embodiments of the present disclosure.

FIG. 2 illustrates an example of a driver device interface for interacting with a routing and recommendation service consistent with embodiments of the present disclosure.

FIG. 3 illustrates a flow chart of an example of a method of interacting with a routing and recommendation service consistent with embodiments of the present disclosure.

FIG. 4 illustrates an example of a system that may be used to implement embodiments of the systems and methods of the present disclosure.

### DETAILED DESCRIPTION

A detailed description of the systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings, wherein like parts may be designated by like numerals or descriptions. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure but is merely representative of possible embodiments of the disclosure. In addition, the steps of any method disclosed herein do not necessarily need to be executed in any specific order, or even sequentially, nor need the steps be executed only once, unless otherwise specified.

Consistent with embodiments disclosed herein, a routing and recommendation service associated with a transportation service may be used to provide targeted recommendations and/or other information to drivers of the transportation service for presentation to passengers that are well-matched to passenger interests. Passenger interests may be ascertained in a variety of ways. For example, a passenger may indicate to a driver that they are hungry, that they enjoy a certain type of activity and/or food, and/or the like. Similarly, passenger interests may be inferred based on an indicated destination of the passenger. For example, if a passenger requests to be driven to a restaurant that serves Lebanese food, it may be inferred that the user is interested in Lebanese and/or Middle Eastern cuisine. In certain embodiments, a driver may interact with a mobile device in communication with the routing and recommendation service to indicate potential passenger interests and receive associated recommendations and/or other information based on the same.

The routing and recommendation service may identify one or more recommended POIs and/or other information based on received indications of potential passenger interests. The identified recommended POIs and/or other information may be communicated to a device associated with the driver, which may be referred to generally herein as a driver device. The driver may present the recommended POIs and/or other information to the passenger, who may choose to visit one or more of the recommended POIs as intermediate destinations during their travels. In some embodiments, if the passenger choses to visit and/or otherwise act on the recommended POI (e.g., patronizing the POI and/or the like), the driver, the transportation service, and/or an associated entity may be compensated for providing the recommendation.

Embodiments disclosed herein may be used in connection with a variety of transportation services and/or recommendation or information targeting systems and methods. For example, the systems and methods described herein can, for example, be used in connection with advertisement matching and/or advertisement targeting technologies such as those described in commonly assigned co-pending U.S. patent application Ser. No. 12/785,406, filed May 21, 2010 (“the '406 application”), and U.S. patent application Ser. No. 12/180,208, filed Jul. 26, 2008, now issued as U.S. Pat. No. 8,565,781 (“the '781 patent”), which are incorporated herein by reference in their entireties.

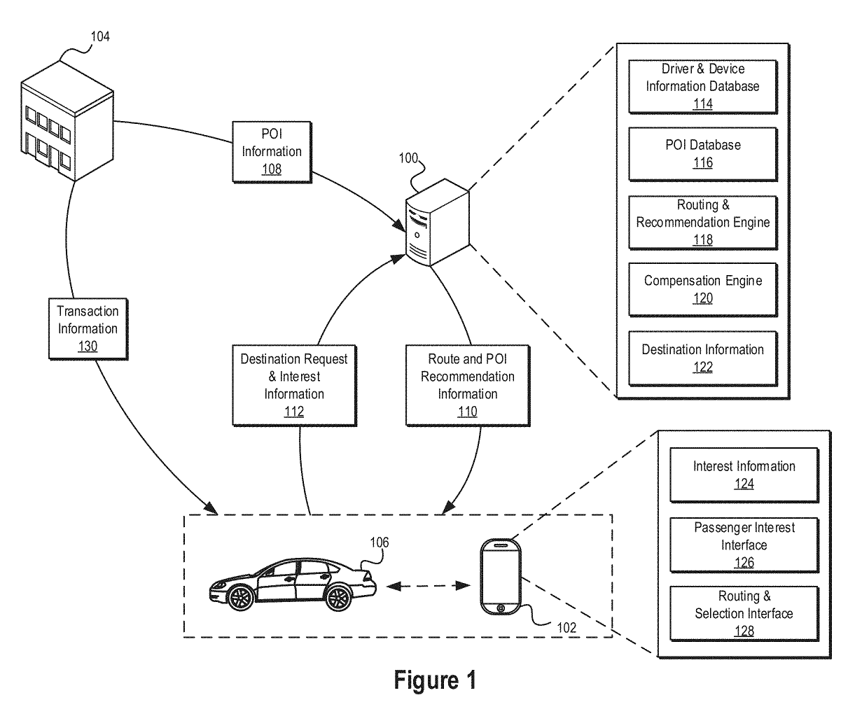

FIG. 1 illustrates a routing and recommendation service 100 consistent with embodiments of the present disclosure. In certain embodiments, the routing and recommendation service 100 may be interact with one or more devices 102 associated with drivers of a transportation service and/or one or more systems 104 associated with a POI. For example, as illustrated, a driver of a transportation service vehicle 106 may be associated with a driver device 102 configured to interact with the routing and recommendation service system 100. Although embodiments disclosed herein are discussed in connection with a transportation service, it will be appreciated that the disclosed embodiments may be used in connection with a variety of other suitable applications and/or services.

The driver device 102, the routing and recommendation service 100, one or more systems 106 associated with a POI, and/or one or more other services or systems may comprise any suitable computing system or combination of systems configured to implement embodiments of the systems and methods disclosed herein. In certain embodiments, the driver device 102, routing and recommendation service 100, one or more systems 106 associated with a POI, and/or one or more other services or systems may comprise at least one processor system configured to execute instructions stored on an associated non-transitory computer-readable storage medium. As discussed in more detail below, the driver device 102, routing and recommendation service 100, one or more systems 104 associated with a POI, and/or one or more other services or systems may further comprise a secure processing unit (“SPU”) configured to perform sensitive operations such as trusted credential and/or key management, secure policy management, and/or other aspects of the systems and methods disclosed herein. The driver device 102, routing and recommendation service 100, one or more systems 104 associated with a POI, and/or one or more other services or systems may further comprise software and/or hardware configured to enable electronic communication of information between the devices and/or services via one or more associated network connections.

The driver device 102, routing and recommendation service 100, one or more systems 104 associated with a POI, and/or one or more other services or systems may comprise one or more computing devices executing one or more applications configured to implement embodiments of the systems and methods disclosed herein. In certain embodiments, the driver device 102 may comprise at least one of a smartphone, a smartwatch, a laptop computer system, a tablet computer, and/or any other computing system and/or mobile device that may be used in connection with the disclosed systems and methods. In certain embodiments, the driver device 102 may comprise software and/or hardware configured to, among other things, obtain information relating to a location of the device 100, driver, and/or an associated vehicle 106.

The driver device 102, routing and recommendation service 100, one or more systems 104 associated with a POI, and/or one or more other services or systems may communicate using a network comprising any suitable number of networks and/or network connections. The network connections may comprise a variety of network communication devices and/or channels and may use any suitable communication protocols and/or standards facilitating communication between the connected devices and systems. For example, in some embodiments, the network may comprise the Internet, a local area network, a virtual private network, and/or any other communication network utilizing one or more electronic communication technologies and/or standards (e.g., Ethernet and/or the like). In some embodiments, the network connections may comprise a wireless carrier system such as a personal communications system (“PCS”), and/or any other suitable communication system incorporating any suitable communication standards and/or protocols. In further embodiments, the network connections may comprise an analog mobile communications network and/or a digital mobile communications network utilizing, for example, code division multiple access (“CDMA”), Global System for Mobile Communications or Groupe Special Mobile (“GSM”), frequency division multiple access (“FDMA”), and/or time divisional multiple access (“TDMA”) standards. In certain embodiments, the network connections may incorporate one or more satellite communication links. In yet further embodiments, the network connections may use IEEE's 802.11 standards, Bluetooth®, ultra-wide band (“UWB”), Zigbee®, and or any other suitable communication protocol(s).

As illustrated, a POI and/or an associated system 104 may transmit information 108 relating to the POI to the routing and recommendation service 100. The information 108 may comprise, for example, location and/or routing information associated with the POI (e.g., an address, a latitude/longitude, etc.), an indication of one or more services and/or products offered by the POI, one or more offers, sales, and/or deals associated with the POI, information that may be used to match the POI with one or more potentially interested parties (e.g., ridesharing service passengers), and/or any other information relating to the POI. The routing and recommendation service 100 may manage information received from one or more POIs in a POI database 116.

Driver devices 102 may be registered with the recommendation and/or routing service 100, and information relating to registered devices 102 and/or associated drivers may be managed in a driver and device information database 114. In some embodiments, a driver may download a ridesharing service application on their device 102 and register their device 102 with the recommendation and/or routing service 100, allowing the device 102 to interact with the recommendation and/or routing service 100 via the application. For example, using the device 102, a driver of the vehicle may receive information from the recommendation and/or routing service 100 regarding potential passengers, accept fares from identified passengers, issue requests regarding route information to a destination, receive responses to such requests, provide information relating to potential user interests, receive POI recommendation information and/or associated routing information, and/or the like. In certain embodiments, the driver and device information database 114 may be updated over time to reflect changes in the associated driver and/or device information and/or based on monitored behavior of the driver and/or usage of the routing and recommendation service 100 by the driver.

In at least one illustrative example, a user of the driver device 102 (e.g., a driver) may transmit request information 112 to the routing and recommendation service 100 requesting information relating to one or more proposed routes and/or directions to a destination. In some embodiments, the request may be sent in conjunction with acceptance of a particular fare associated with a prospective passenger by a driver of the vehicle 106. For example, a driver of the vehicle 106 may be presented with indications of one or more prospective passengers and associated destinations (i.e., fares) via an application executing on the driver device 102. The driver may accept a particular fare and, in response, the driver device 102 may issue a request to the routing and recommendation service 100 for one or more proposed routes and/or directions to a destination associated with the accepted fare.

In response, a routing and/or recommendation engine 118 executing on the routing and recommendation service 100 may provide the driver device 102 with response information 110 comprising one or more recommended routes to the destination. For example, in some embodiments, the routing and recommendation engine 118 may access map, location, and/or other destination information, which may be managed by the routing and recommendation service 100 and/or one or more other services. Based on the accessed information, one or more recommended routes to the destination may be identified by the routing and recommendation engine 118.

In some embodiments, multiple proposed routes may be provided to the driver device 102, and the driver may select a desired route from the multiple proposed routes. Intermediate directions and/or turn-by-turn instructions may be provided to the user for selected and/or otherwise identified routes that may be dynamically updated based on location information associated with the device 102 that is communicated to the routing and recommendation service 100 (e.g., global positioning system (“GPS”) location information and/or the like). Various interactions between a driver of the vehicle 106 and the device 102 described herein may be facilitated by a passenger interest interface 126 and/or a routing and selection interface 128 of the device 102.

Consistent with embodiments disclosed herein, the driver device 102 may communicate information 112 to the routing and recommendation service 100 indicative of potential passenger interests. In some embodiments, passenger interests may be reflected in interest information 124 collected and/or maintained by the driver device 102. Potential passenger interests may be ascertained in a variety of ways including, without limitation, through direct interaction between a driver and a passenger, from interferences derived from the nature of a passenger's destination, and/or the like. For example, a driver of the vehicle 106 may notice that a passenger is wearing a jersey from a baseball team, and may therefore conclude that the passenger is likely a sports and/or baseball fan. In another example, a passenger may convey to a driver of the vehicle 106 that they would like to listen to a rock radio station, and the driver may therefore conclude that the passenger is likely a fan of rock music. The driver may thus enter indications of these potential passenger interests into a passenger interest interface 126 of their associated device 102 for communication to the routing and recommendation service 100. In some embodiments, passenger interest information may be communicated to the routing and recommendation service 100 concurrently and/or separate from an associated destination request 112.

In certain embodiments, passenger interests may be determined based on inferences derived from the nature of a passenger's destination (e.g., determined by the driver device 102 and/or the routing and recommendation service 100). For example, if a passenger's destination is a baseball stadium, it may be inferred that the passenger is likely a sports and/or baseball fan. The routing and recommendation service 100 may maintain a destination information database 122 associating various destinations with one or more associated interests. Accordingly, based on a received destination request 112, the routing and/or recommendation engine 118 may identify one or more potential interests associated with a passenger based on their destination.

Based on the identified potential passenger interests, one or more POIs associated with the passenger interests may be identified by the routing and/or recommendation engine 118. For example, information included in the POI database 116 may include various interests related and/or otherwise associated with various POIs. Accordingly, based on indicated passenger interests, one or more POIs associated with information included in the POI database 116 may identified that are reflective of the passenger's interests.

The routing and recommendation engine 118 may further identify one or more routes to a passenger's destination that include the one or more identified POIs as an intermediate destination. Identified POIs and well as associated information (e.g., offers, sales, deals, etc.) and routing information (e.g., one or more proposed routes) to an indicated destination that visits one or more of the recommended POIs may be communicated from the routing and recommendation service 100 to the driver device 102 in connection with route and POI recommendation information 110.

A driver of the vehicle 106 may interface with a routing and selection interface 128 of the driver device 102 to select one or more routes and/or associated POIs, offers, sales, deals, and/or the like. For example, after ascertaining that a passenger is interested in sports, a driver may provide an indication to the routing and recommendation service 100 of the passenger's potential interest. In response, the routing and recommendation service 100 may identify a sports memorabilia shop as an intermediate POI proximate to a route to the passenger's destination and present the intermediate POI to a driver via the driver device 102 for recommendation to the passenger. The driver may the personally recommend the identified POI and/or present other information associated with the POI (e.g., associated offers, sales, deals, etc.) to their passenger for consideration.

In certain embodiments, if a passenger choses to visit and/or otherwise act on driver's recommendation, (e.g., patronizing the POI, accepting an offer, and/or the like), the driver, the transportation service and/or an associated entity may be compensated by the POI and/or an associated entity for providing the realized recommendation. In some embodiments a compensation engine 120 associated with the routing and recommendation service 100 may be configured to orchestrate a compensation transaction involving a POI, the recommendation and routing service 100, an associated transportation service, and/or the driver. For example, after determining that a recommendation has be acted on and/or otherwise accepted, the compensation engine 120 may credit an account associated with a driver of the vehicle 106 for the realized recommendation.

The determination that a recommendation has been acted on, accepted, and/or otherwise realized may be based on a variety of methods. For example, it may be determined that a POI recommendation has been realized when a driver selects a particular recommended POI on a routing and selecting interface 128 of the driver device 102. In further embodiments, it may be determined that a POI recommendation has been realized based on location information received from the vehicle 106 indicating that the vehicle 106 visited the POI location. In yet further embodiments, information may be transmitted from a POI system 104 to the routing and recommendation service 100 indicating that a recommendation was realized (e.g., a purchase confirmation from the POI and/or the like).

In some embodiments, information may be communicated from the routing and recommendation service 100 to one or more POI systems 104 when a driver of the vehicle 106 provides passenger interest information 112 to the routing and recommendation service 100. For example, one or more POI systems 104 may subscribe to a recommendation service network associated with the routing and recommendation system 100. Based on information received form the system 100 indicative of a passenger's interest, destination, and/or associated route, the one or more POIs may choose to provide POI information 108 and/or associated deals, offers, sales, and/or the like to the system 100 for presentation to potentially interested passengers consistent with embodiments disclosed herein.

In some embodiments, if a deal, offer, sale, and/or the like presented by a driver to a passenger is realized and/or otherwise acted on, a transaction may be effectuated between a POI and/or a system 104 associated with the same and/or the driver of the vehicle 106 and/or an associated device 102. For example, transaction information 130 may be communicated from the POI system 102 to the driver device 102. In further embodiments, the POI system 102 may communicate the transaction information to the routing and recommendation system 100 and/or one or more other service provider systems (e.g., financial service providers and/or the like).

It will be appreciated that a number of variations can be made to the architecture, relationships, and examples presented in connection with FIG. 1 within the scope of the inventive body of work. For example, certain device and/or system 100-104 functionalities described above may be integrated into a single device and/or system and/or any suitable combination of devices and/or systems in any suitable configuration. Indeed, various functionalities of the driver device 102 may be performed by the routing and recommendation system 100. Similarly, various functionalities of the routing and recommendation service system 100 may be performed by the driver device 102. Thus it will be appreciated that the architecture, relationships, and examples presented in connection with FIG. 1 are provided for purposes of illustration and explanation, and not limitation.

### EXAMPLE

### Product Recommendations Based on Communicated User Interests

In one example, a frequent traveler may be visiting a location for a meeting. The traveler may be picked up at the airport by a driver of a transportation service. The driver may participate in a recommendation service and/or network consistent with embodiments disclosed herein. Noticing that the passenger has had a long journey and appears hungry, the driver may alert the recommendation service of his passenger's circumstances.

In some embodiments, participants in the recommendation service network (e.g., POIs and/or the like), may be notified of the driver's alert. Based on a selected and/or otherwise expected route of the driver's vehicle and/or other relevant parameters (e.g., real time traffic information and/or the like), possible POIs of interest to the passenger may be identified and communicated to the driver's device. For example, two possible fast fresh restaurants may be identified and presented to the driver for consideration by their passenger.

In certain embodiments, the proposed POIs may be presented to the passenger on the driver's device and/or a device associated with the vehicle, and/or may be communicated to a device associated with the passenger. In some embodiments, the proposed POIs may further include reviews of the POIs from other patrons. The passenger may select a POI they would like to visit on the way to their meeting and/or notify the driver of their interest in the POI. In some embodiments, the POI may be notified in advance of the passenger's impending arrival, allowing for products and/or services to be delivered in a relatively expedient fashion. In certain embodiments, the POI may be compensated directly for the products and/or services purchased by and/or rendered to the passenger. In other embodiments, the cost of the products and/or services may be added to an account associated with the passenger, and proper payment to the driver and the POI may be facilitated at a later time.

### EXAMPLE

### Dynamic Recommendation of POIs

In some embodiments, participants in a recommendation service network may dynamically negotiate offers associated with POIs as a route is traversed. Recommended routing may be recalculated based, at least in part, on accepted or rejected offers.

In one example, a person may require transportation between a variety of destinations due, for example, to an inoperable personal vehicle. For example, the person may wish to visit a friend's residence in the evening, but also purchase a dress shirt, a bottle of wine, and refreshments prior to their visit. The person may thus issue a request to a transportation service using a mobile device for transport to their friend's residence. In connection with this request, the person may further include an indication of their intended intermediate destinations (e.g., a clothing store, a wine store, a grocery store, etc.) and/or the items they intend to pick up prior to arrival at their friend's residence.

Upon receipt of the request, a driver for the transportation service may be alerted of the person's intended destination on a driver device, as well as the indicated intermediate destinations and/or their needed items. Using their driver device, the driver may alert various participants in a recommendation service network of the intended destination and the indicated intermediate destinations and/or needed items. For example, the driver may interact via an up-sell network browser of the mobile device that their passenger needs to visit a clothing store, a wine store, and a grocery store on the way to their destination. A routing and recommendation service may identify one or more routes to the destination and/or one or more POIs or offers targeted to the passenger's needs.

Prior to picking up the passenger, the driver may stop at one or more of the POIs (e.g., a grocery store). The POI may track the driver's progress via a proximity browser of an associated mobile device, allowing the POI to prepare any products for prompt delivery to the driver. Upon arriving at the POI, the driver may be greeted by a representative of the POI for curb-side delivery of the requested products. The driver may then proceed to pick up their passenger at their home, dropping off some of the product along the way.

En route, the passenger may mention another request to the driver, who may enter this additional request into their mobile device for identification of associated POIs by the recommendation service network. Identified additional POIs may be indicated to the passenger, who may select one or more additional POIs. A new route may be calculated to the friend's residence based on the newly selected POI.

In some embodiments, a POI may provide offers based on profile information associated with a passenger. For example, a wine store POI may note that the passenger is a wine aficionado and may be interested in attracting their future business. Accordingly, the wine store POI may provide a heavily discounted initial offer to the passenger to increase the likelihood that the passenger chooses to visit the wine store as an intermediate destination. Offers may be similarly adjusted and/or otherwise customized based on an associated time of arrival. For example, a POI may note that the passenger would arrive at the POI after normal business hours, and may thus adjust pricing upwards to reflect additional potential overtime costs. In further embodiments, the passenger may provide review information associated with the services offered by the driver and/or any visited POIs.

### EXAMPLE

### Device Browser Interfaces

As discussed above, various participants may interact with the routing and recommendation service and/or network using one or more associated electronic devices. In some embodiments, these devices may implement one or more browsers and/or interfaces based on associated activities and/or roles in connection with the service and/or network. For example, “Sell Browsers” may securely communicate offers, counter offers, acceptance criteria, and probability metrics to the “Up-sell Network Browsers”. In some embodiments, proposals may be ordered according to preference. A “Sell Browser” may further show peripheral information to support the transaction such as time left until the arrival of a customer. Customer preferences, merchant ratings and other derived information can also be displayed.

A “Transport Browser” may be used to identify routes to a driver and/or a passenger that may be selected according to some optimization criteria. In some embodiments, the “Transport Browser” may negotiate with a routing and recommendation service in order to identify and/or otherwise present a set of potential paths.

A “Proximity Browser” may overlay a representation of geography with potential commercial proposals and/or POIs. This browser may, among other things, allow a user to view various offerings, POIs, order them according to preference, and/or view the location of these offers and/or POIs.

### EXAMPLE

### Augmentation of User-Published Data

Embodiments of the disclosed systems and methods may further be used in connection with augmenting information published by participants (e.g., POIs and/or the like) with other data sources available to the user's interacting with the system, thereby improving the utility of the disclosed embodiments in making more informed user decisions. In one example, a homeowner may discover that they have an appliance in need of repair and may thus need to find a cost effective repairperson skilled in dealing with their specific brand of appliance.

While traveling to an appointment, the homeowner may travel close to a skilled repairperson that may help them. The homeowner may not know the repairperson, but the repairperson may be identified to the homeowner based on their relative proximity and aligning interests and skills using embodiments of the disclosed recommendation system. The homeowner may be notified of their location relative to the repairperson, and may be provided with an indication of past customer reviews associated with the repairperson. Based on this information, the homeowner may choose to connect with the repairperson, negotiate a price, and/or have their appliance repaired.

### EXAMPLE

### Simulation of a User's Anticipated Environment

In further embodiments, user devices may be provided with an indication of their future and/or anticipated environment or surroundings, enabling associated users to make more informed decisions. In one example, a person may be planning on taking public transport to visit their friend on the other side of town. The person may estimate that it will take them 20 minutes to walk to a bus station, putting their total travel time at one hour. Hoping to shorten their travel time, the person may use an associated mobile device to identify nearby drivers of a ridesharing service heading in their intended direction. Finding none, the person may adjust associated identification parameters to identify passengers that will be nearby in 10 minutes and may request a ride from a selected driver.

The selected driver may receive a notice on their mobile device that the person needs a ride and that they will be passing nearby in approximately 10 minutes. The driver may offer a price to travel to the person's destination and, upon acceptance, may pick up the person for the journey. In some embodiments, profile data may be provided to the driver and/or the passenger reflecting, for example, common interests for discussion en route.

### EXAMPLE

### Intelligent Filtering of Projected Information

In some embodiments, information projected on a physical landscape shown on a mobile device may be intelligently filtered based on user preferences, interests, an intended destination, past user activities, the time of day, and/or the like. For example, a sales person may be attending a trade show, and may be interested in attending various parties sponsored by trade show attendees. The sales person may enter various appropriate filters into a mobile device and, while roaming the trade show floor, may be provided with an indication of the trade shows attendees that are hosting parties of interest to the salesperson.

### EXAMPLE

### Aggregation of Ridesharing Service Providers

In some embodiments, a prospective passenger may interact with a transportation service aggregator in connection with identifying a particular vehicle and/or driver to transport them to a desired destination. For example, a plurality of ridesharing service providers and/or available drivers may register their availability with a transportation service aggregator system. By interacting with the transportation service aggregator, the passenger may view and/or select an available driver consistent with various aspects of the disclosed embodiments. In certain embodiments, various participants that register their services with the transportation service aggregator (e.g., ridesharing service providers, drivers, other transportation services, etc.) may engage in a competitive bidding process administered by the transportation service aggregator impacting how their services are displayed to prospective passengers, the price of such services, and/or the like.

### EXAMPLE

### Passenger Intelligence Information

In some embodiments, various profile information relating to a passenger may be presented to a driver of a vehicle to better enable them to successfully convey recommendations to passengers. For example, in connection with presenting recommendations, a driver may be presented on their associated device with various demographic information associated with a passenger, historical interest information associated with the passenger (e.g., prior destinations, prior recommendations that have been acted on by the passenger, and/or the like). Such information may be used by the driver to improve the chances that a recommendation is realized when it is offered to a passenger. In further embodiments, past ride history and/or other information associated with drivers and/or passengers may be used in connection with matching available drivers with prospective passengers, thereby improving the chances that offered recommendations are acted upon (e.g., driver and/or passenger reviews, recommendation realization history, etc.).

### EXAMPLE

### Routing Goods and Services to Passenger Destinations

In some embodiments, various recommendations offered by POIs and/or other service providers may not require a passenger to be rerouted to an intermediate destination, but may be associated with products and/or services that can be delivered and/or otherwise performed at an intended destination. For example, en route to an airport, a driver may determine that their passenger is hungry. The driver may present to the passenger one or more options for food items that may be delivered to the airport at or near the same time at the passenger's expected arrival. If the driver accepts one of the options, the associated food vendor may be notified and may proceed to prepare and deliver the food item to the airport upon the passenger's arrival.

Driver Device Interface

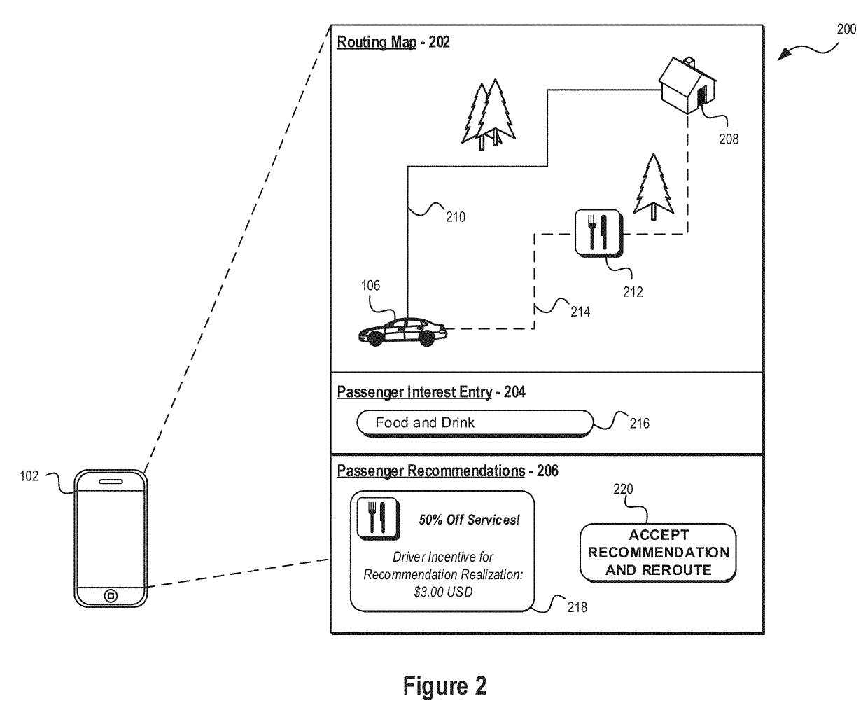

FIG. 2 illustrates an example of an interface 200 of a driver device 102 for interacting with a routing and recommendation service consistent with embodiments of the present disclosure. In certain embodiments, various aspects of the driver device interface 200 may be used in connection with providing routing directions for a vehicle 106 to a destination 208, entering potential passenger interests, and/or viewing various returned passenger recommendations including identified POIs and/or associated information.

As illustrated in FIG. 2, the interface 200 may include a routing map portion 202 displaying a map showing a route 210 to an indicated destination 208 for a vehicle 106. Although not specifically illustrated, the routing map portion 202 may further display intermediate directions and/or turn-by-turn instructions that may be dynamically updated based on location information associated with the driver device 102 that is communicated to the routing and recommendation service (e.g., GPS location information and/or the like). In certain embodiments, the routing map portion 202 may display a plurality of routes to an indicated destination 208 for a vehicle 106, and a driver of the vehicle may select a route 210 from the plurality of routes by interacting with the interface 200.

A passenger interest entry portion 204 of the interface 200 may be used by a driver to enter passenger interest information for communication from the driver device 102 to the routing and recommendation service. Potential passenger interests may be ascertained in a variety of ways including, without limitation, through direct interaction between a driver and a passenger, from interferences derived from the nature of a passenger's destination, and/or the like. For example, a passenger may indicate to a driver that they are feeling hungry. In response, the driver may enter “food and drink” as a potential user interest into an interest entry field 216 of the passenger interest entry portion 204 of the interface 200. In another example, a passenger may indicate they would like to be taken to a restaurant and, in response, the driver may enter “food and drink” as a potential user interest into an interest entry field 216 of the interface 200.

The driver device 102 may communicate passenger interest information to a routing and recommendation service. In response, the driver device 102 may receive from the routing and recommendation service information associated with one or more POIs based on the identified passenger interests. In certain embodiments, the one or more intermediate POIs may be displayed on the routing map portion 202 of the interface 200. For example, as illustrated, based on passenger interest information indicating a passenger is hungry, the routing and recommendation service may return information relating to a restaurant 212 proximate to a route 210 for the vehicle 106 to the destination 208. The location of the restaurant 212 may be displayed in the routing map portion 202 of the interface 200 along with a proposed alternative route 214 for the vehicle 106 to the destination 208 that also visits the restaurant 212.

Information associated with the one or more POIs received from the routing and recommendation service may be personally conveyed to a passenger by a driver of the vehicle 106 for consideration. In some embodiments, various information related to POIs may be displayed to the driver in a passenger recommendation portion 206 of the interface 200 of the driver device 102. For example, as illustrated, a passenger recommendation portion 206 of the interface 200 may provide an information window 218 associated with a POI such as restaurant 212. The information window 218 may provide, among other things, information relating to one or more services and/or products offered by the POI, one or more offers, sales, and/or deals associated with the POI, information relating to compensation and/or remuneration to be paid to a transportation service and/or driver if a recommendation is accepted and/or otherwise realized, and/or any other information relating to a POI that a driver may wish to convey to a potentially interested passengers.

In certain embodiments, the passenger recommendation portion 206 of the interface 200 may further include a selection button 220 for accepting a particular recommendation (e.g., a particular recommended POI, offer, sale, and/or deal associated with the same, and/or the like). When selected, the routing map portion 202 may be updated to reflect the POI as an intermediate destination along with an updated route to the destination 208 that visits the POI. For example, as illustrated in FIG. 2, after selecting restaurant 212 as a POI to visit using selection button 220, the routing map portion 202 may be updated to reflect directions along route 214 to the destination 208 that visits the restaurant 212 as an intermediate destination.

Routing and Recommendation Service Interaction

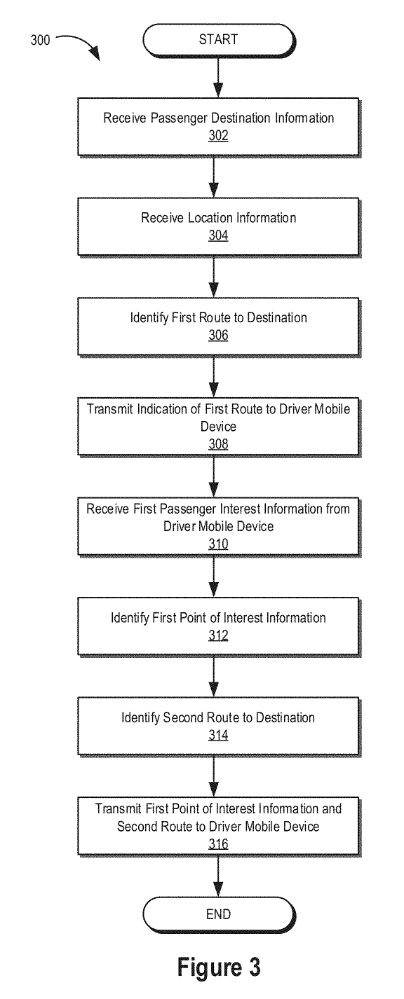

FIG. 3 illustrates a flow chart of an example of a method 300 of interacting with a routing and recommendation service consistent with embodiments of the present disclosure. The illustrated method 300 may be implemented in a variety of ways, including using software, firmware, hardware, and/or any combination thereof. In certain embodiments, various aspects of the method and/or its constituent steps may be performed by routing and recommendation service system, a system associated with a POI, a driver device, and/or any other suitable system or combination of systems.

At 302, passenger destination information may be received (e.g., received by a routing and recommendation service system). In certain embodiments, the passenger destination information may be received from a mobile device associated with a passenger. In further embodiments, the passenger destination information may be received a mobile device associated with a driver of the vehicle. Among other things, the passenger destination information may comprise a description of a destination and/or location information associated with the same (e.g., a latitude and/or longitude or other GPS location information associated with the destination, an address of the destination, etc.).

Location information may be received from a mobile device associated with a driver of a vehicle at 304. In some embodiments, the location information may indicate a location of the mobile device and/or by extension, a location of the vehicle. The location information may comprise any suitable type of location information including, for example, latitude and/or longitude or other GPS location information associated with the driver mobile device and/or vehicle, an address of the driver mobile device and/or vehicle, and/or the like.

At 306, at least one first route to the destination may be identified based, at least in part, on the received passenger destination information and the location information. A first indication of the at least one first route may be communicated to the mobile device associated with the driver of the vehicle at 308. In some embodiments, a first selection of the at least one first route to the destination may be received from the driver's mobile device. In response, first directions associated with the at least one first route to the destination may be transmitted to the driver's mobile device (e.g., turn by turn directions, map directions, and/or the like).

First passenger interest information may be received from the mobile device associated with the driver at 310. In some embodiments, the first passenger interest information may be entered into the mobile device by a driver of the vehicle. In further embodiments, the first passenger interest information may be derived from an indicated destination provided to the driver by a passenger of the vehicle. In further embodiments, the first passenger interest information may not necessarily be received from a mobile device associated with the driver, may be derived and/or otherwise inferred from information relating to prior purchases, activities, and/or profile information associated with the passenger.

Based on the received first passenger interest information and the at least one first route, point of interest information associated with at least one first point of interest may be identified at 312. In some embodiments, the at least one first point of interest may comprise a point of interest associated with the received passenger interest information that is proximate to the at least one first route. The first point of interest information may comprise, among other things, one or more of a description of the first point of interest (e.g., a written description, one or more photographs provided by the first point of interest and/or captured by other users, information provided by a review and/or other third-party service), one or more sales, deals, and/or offers associated with the first point of interest, and/or the like. In certain embodiments, the one or more sales, deals, and/or offers may be based, at least in part, on an identity of the passenger and/or the received passenger interest information. In further embodiments, plural points of interest may be identified based on the first passenger interest information and the at least one first route.

At 314, at least one second route to the destination may be identified based on the received passenger destination information, the location information, and the first point of interest information. An indication of the at least one second route and the first point of interest information may be transmitted at 316 to the mobile device associated with the driver of the vehicle for consideration and/or presentation to the passenger. In instances where plural points of interest of identified, plural routes to the destination may be identified and transmitted to the driver's mobile device associated with the identified plural points of interest.

In further embodiments, the method 300 may additionally comprise receiving from the mobile device associated with the driver of the vehicle a first selection of the first point of interest information. In response, second directions associated with the at least one second route may be transmitted to the driver's mobile device. In additional embodiments, an indication of a realized visit to the first point of interest and/or a transaction between a passenger of the vehicle and the first point of interest may be received. In response to receiving the indication, a transaction between the first point of interest and the driver of the vehicle may be initiated. In further embodiments, a transaction between the first point of interest, the routing and recommendation system, and/or the passenger may be similarly initiated (e.g., a transaction that reduces and/or otherwise offsets a portion of the fare associated with the trip and/or the like). In some embodiments, information obtained as part of a transaction may be used to enhance various services and/or build a profile of a passenger for use in future information targeting interactions.

System and Device Architecture

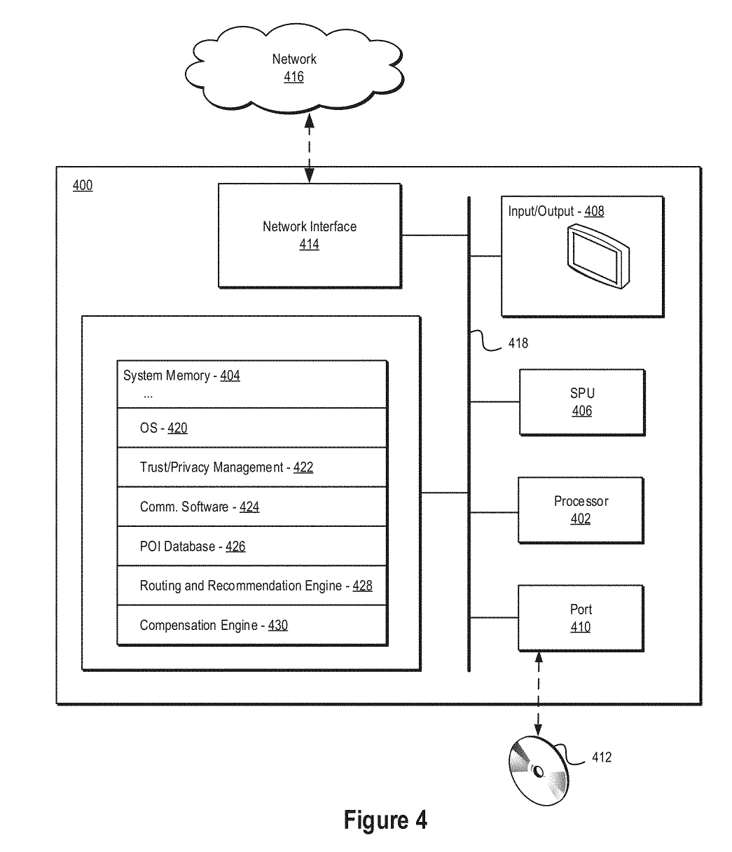

FIG. 4 illustrates an exemplary system 400 that may be used to implement embodiments of the systems and methods of the present disclosure. Certain elements associated with the illustrated exemplary system 400 may be included in a driver device, a system associated with a POI, a routing and/or recommendation system, and/or any other system configured to implement embodiments of the disclosed systems and methods. As illustrated in FIG. 4, the system 400 may include: a processing unit 402; system memory 404, which may include high speed random access memory (“RAM”), non-volatile memory (“ROM”), and/or one or more bulk non-volatile non-transitory computer-readable storage mediums (e.g., a hard disk, flash memory, etc.) for storing programs and other data for use and execution by the processing unit 402; a port 410 for interfacing with removable memory 412 that may include one or more diskettes, optical storage mediums, and/or other non-transitory computer-readable storage mediums (e.g., flash memory, thumb drives, USB dongles, compact discs, DVDs, etc.); a network interface 414 for communicating with other systems via one or more network connections 416 using one or more communication technologies; a user interface 408 that may include a display and/or one or more input/output devices such as, for example, a touchscreen, a keyboard, a mouse, a track pad, and the like; and one or more busses 418 for communicatively coupling the elements of the system. In certain embodiments, the system 400 may include and/or be associated with one or more sensors configured to collect various information relating to an environment surrounding the system 400 including, for example, a location of the system 400. Such sensors may comprise, without limitation, GPS and/or other location sensors, audio sensors, video and/or image sensors, and/or any other type of sensor.

In some embodiments, the system 400 may, alternatively or in addition, include an SPU 406 that is protected from tampering by a user of the system 400 or other entities by utilizing secure physical and/or virtual security techniques. An SPU 406 can help enhance the security of sensitive operations such as personal information management, trusted credential and/or key management, privacy and policy management, and other aspects of the systems and methods disclosed herein. In certain embodiments, the SPU 406 may operate in a logically secure processing domain and be configured to protect and operate on secret information, as described herein. In some embodiments, the SPU 406 may include internal memory storing executable instructions or programs configured to enable the SPU 406 to perform secure operations, as described herein.

The operation of the system 400 may be generally controlled by the processing unit 402 and/or the SPU 406 operating by executing software instructions and programs stored in the system memory 404 (and/or other computer-readable media, such as removable memory 412). The system memory 404 may store a variety of executable programs or modules for controlling the operation of the system. For example, the system memory may include an operating system (“OS”) 420 that may manage and coordinate, at least in part, system hardware resources and provide for common services for execution of various applications and a trust and privacy management system 422 for implementing trust and privacy management functionality including protection and/or management of personal data through management and/or enforcement of associated policies. The system memory 404 may further include, without limitation, communication software 424 configured to enable in part communication with and by the system 400; one or more applications; a POI database 426 including information relating to various POIs and/or associated offers; a routing and recommendation engine 428 configured to, among other things, recommend various POIs and/or offers to drivers and/or passengers, provide routing information to various destinations and/or POIs, and/or the like; a compensation engine 430 configured to facilitate compensation of appropriate participants in a recommendation service network; and/or any other information and/or applications configured to implement embodiments of the systems and methods disclosed herein.

The systems and methods disclosed herein are not inherently related to any particular computer, device, service, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers, at one site or distributed across multiple sites and interconnected by a communication network.

Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, an optical storage medium, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to be limited to the details given herein, but may be modified within the scope and equivalents of the appended claims.

What is claimed is:

1. A method for providing a recommendation performed by a routing and recommendation service system, the routing and recommendation system comprising a processor and a non-transitory computer-readable medium storing instructions that, when executed by the processor, cause the processor to perform the method, the method comprising:
receiving passenger destination information;
receiving location information from a driver mobile device, the driver mobile device being associated with a driver, the location information indicating a location of a vehicle associated with the driver;
identifying at least one first route to a destination based, at least in part, on the received passenger destination information and the location information;
transmitting a first indication of the at least one first route to the destination to the driver mobile device;
receiving first passenger interest information from the driver mobile device;
identifying first point of interest information associated with at least one first point of interest based, at least in part, on the first passenger interest information and the at least one first route;
identifying at least one second route to the destination based, at least in part, on the received passenger destination information, the location information, and the first point of interest information; and
transmitting the first point of interest information and the at least one second route to the driver mobile device for presentation to the driver.

2. The method of claim 1, wherein the passenger destination information is received from a mobile device associated with a passenger.

3. The method of claim 1, wherein the passenger destination information is received from the driver mobile device.

4. The method of claim 1, wherein the method further comprises:
receiving from the driver mobile device a first selection of the at least one first route to the destination; and
transmitting first directions associated with the at least one first route to the destination to the driver mobile device.

5. The method of claim 1, wherein the first directions comprise turn by turn directions.

6. The method of claim 1, wherein the location information comprises longitude and latitude information generated by a global positioning system.

7. The method of claim 1, wherein the first point of interest information comprises a description of the first point of interest.

8. The method of claim 7, wherein the description of the first point of interest comprises one or more photographs of the first point of interest.

9. The method of claim 1, wherein the first point of interest information comprises a description of an offer associated with the first point of interest.

10. The method of claim 9, wherein the offer associated with the first point of interest is based, at least in part, on the first passenger interest information.

11. The method of claim 1, wherein the method further comprises:
receiving from the driver mobile device a first selection of the first point of interest information; and
transmitting second directions associated with the at least one second route to the driver mobile device.

12. The method of claim 1, wherein the method further comprises:
identifying second point of interest information associated with at least one second point of interest based, at least in part, on the first passenger interest information and the at least one first route;
identifying at least one third route to the destination based, at least in part, on the received passenger destination information, the location information, and the second point of interest information; and
transmitting the second point of interest information and the at least one third route to the mobile device to the driver mobile device for presentation to the driver.

13. The method of claim 1, wherein the method further comprises:
receiving an indication of a realized visit to the first point of interest by a passenger of the vehicle; and
in response to receiving the indication of the realized visit, orchestrating a transaction between the first point of interest and the driver.

14. The method of claim 1, wherein the method further comprises:
receiving an indication of a realized transaction between a passenger of the vehicle and the first point of interest; and
in response to receiving the indication of the realized transaction, orchestrating a transaction between the first point of interest and the driver.
